(19) United States
(12) Patent Application Publication
(10) Pub. No.: US 2024/0087803 A1
(43) Pub. Date: Mar. 14, 2024

(54) SHIELD FOR A WIRELESS CHARGING SYSTEM

(71) Applicant: EGGTRONIC ENGINEERING SPA, Modena (IT)

(72) Inventors: Igor SPINELLA, Modena (IT); Camilla BETTINELLI, Modena (IT); Simone BONETTI, Modena (IT); sERENA sacchetto, Modena (IT); Alice ROVERSI, Modena (IT)

(21) Appl. No.: 18/262,286

(22) PCT Filed: Jan. 20, 2022
(86) PCT No.: PCT/EP2022/051276

§ 371 Date: Jul. 20, 2023

(30) Foreign Application Priority Data
Jan. 20, 2021 (GB) 2100731.5

(51) Int. Cl. H01F 27/36; H02J 50/00; H02J 50/10; H02J 50/70; H02J 50/90

(52) U.S. Cl. CPC H01F 27/366; H02J 50/005; H02J 50/10; H02J 50/70; H02J 50/90

(57) ABSTRACT

There is provided a shield for a wireless charging system including a transmitter coil and a receiver coil. The shield includes a thin sheet or layer made of soft or nanocrystalline ferrite. The shield is partly located, in use, between the transmitter coil and the receiver coil. The shield is shaped or otherwise configured to focus or orient a magnetic flux generated by the transmitter coil onto the receiver coil.

### BACKGROUND OF THE INVENTION

### 1. Field of the Invention

The field of the invention relates to a shield for a wireless charging system and to related systems and methods.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

Wireless charging enables the charging of electronic devices without cables, and comprises a wireless charger including a transmitter coil and an electronic device including a receiver coil. The transmitter coil generates a magnetic field that is received by the receiver coil that in turns provides electrical energy to a rechargeable battery inside the electronic device.

Various portable electronic devices now offer wireless charging capabilities. However the high fragmentation of the wireless power market often leads to an unavoidable geometrical mismatch between receiver and transmitter coils. This may result in a considerable loss of magnetic energy, particularly when the distance between transmitter and receiver coils increases, or when the wireless charger and electronic device are misaligned, or when transmitter and receiver coils exhibit significantly different shapes or dimensions.

There is a need for a solution that achieves a better control of the magnetic flux between transmitter and receiver coils in order to provide improved wireless charging systems.

### SUMMARY OF THE INVENTION

The invention relates to a shield for a wireless charging system including a transmitter coil and a receiver coil, in which the shield includes a thin sheet or layer made of soft or nanocrystalline ferrite, and in which the shield is a) partly located, in use, between the transmitter coil and the receiver coil; and b) shaped or otherwise configured to focus or orient a magnetic flux generated by the transmitter coil onto the receiver coil.

A consolidated list of key features is at the Appendix.

### BRIEF DESCRIPTION OF THE FIGURES

Aspects of the invention will now be described, by way of example(s), with reference to the following Figures, which each show features of the invention:

FIG. 1A shows the cross-section of an inductive wireless charging system, when the transmitter coil is relatively far from the receiver coil.

FIG. 1B shows the cross-section of an inductive wireless charging system, when the transmitter coil is significantly larger from the receiver coil.

FIG. 2A shows the cross section of an inductive wireless charging system including a shield, when the transmitter coil is relatively far from the receiver coil.

FIG. 2B shows the cross section of an inductive wireless charging system including a shield, when the transmitter coil is significantly larger from the receiver coil.

FIG. 3 shows the receiver coil 12 integrated in a portable electronic device 31, and a shield placed on top of the charger.

FIG. 4 shows an example of a shield configured to be located between a transmitter coil and a receiver coil.

FIG. 5 shows another example of a shield configured to be located between a transmitter coil and a receiver coil.

FIG. 6 shows the shield of FIG. 4 being integral to the case or accessory of a portable electronic device.

FIG. 7 shows the shield of FIG. 5 being integral to the case or accessory of a portable electronic device.

FIG. 8 shows a wireless charging system including a shield, a triple coil charger and a receiver coil.

FIG. 9A shows the top view of the shield of FIG. 8.

FIG. 9B shows the top view of another configuration for the shield that includes three cavities or holes.

FIG. 9C shows a plot of the coupling coefficient k between the transmitter and receiver coils as a function of varying the radius R of the hole included in the shield.

FIG. 9D shows a plot of ohmic loss and the magnetic field on the magnets 84 as a function of varying the radius R of the hole included in the shield.

FIG. 10A shows the two coils of a repeater device, separated by a ferrite shield.

FIG. 10B shows a cross view of the repeater device including the shield.

FIG. 11 shows a representation of the magnetic field lines when the repeater device 110 is located between a transmitter coil 11 and receiver coil 12.

FIG. 12A shows an implementation of the receiver coil and transmitter coil of a repeater device, with coils plated on a substrate.

FIG. 12B shows a side view of the shield including the sheet of soft ferrite and the repeater device located on a folded substrate.

FIG. 12C shows an isometric view of the shield including the sheet of soft ferrite and the repeater device located on a folded substrate.

FIG. 13 shows a spiral configuration of the coils of the repeater device (when the substrate is not yet folded).

FIG. 14 shows an adjustment mechanism including a manual slider.

FIG. 15 shows another configuration of the shield for a wireless charging system in which magnets are located at the side of the receiver coil.

### DETAILED DESCRIPTION

In this description, the term ‘soft ferrite’ may include any ferromagnetic materials capable of guiding a magnetic flux, thanks to a sufficiently low level of magnetic coercivity, and hence a magnetization profile relatively easy to be changed, ensuring at the same time good efficiency and high capability to shield and guide a magnetic field. As an example, it may include powder ceramic ferrite or nanocrystalline structures or any soft ferrites containing for example iron, nickel, zinc and/or manganese. Examples of ferrite material include standard ferrite with relative magnetic permeability from 100 to 900 or nanocrystalline ferrite with relative magnetic permeability of up to 2000. Ferrite materials provide a number of advantages in terms of versatility, cost, stability and wear resistance, as well as control over magnetization.

Together with high magnetic permeability, ferrites are also characterised by high electrical resistance, giving rise to reduced eddy currents and hence limited temperature increase in case of a magnetic field. This feature represents a distinguishing point for ferrites, as compared to generic ferromagnetic materials like magnets: the latter tend to heat up in presence of a magnetic field due to non negligible internal currents.

A shield or screen for a wireless charging system including a transmitter coil and a receiver coil is provided to achieve a simple and effective tool to enhance the performance of wireless charging system. The wireless charging system may be configured to operate under a plurality of charging protocols, such as the Qi standard.

The shield is configured to improve the performance of wireless charging systems by focusing or orienting the magnetic flux generated by the transmitter coil onto the receiver coil while reducing power losses. Additionally and as will be apparent below, the shield may also include an electronic device or component, for example a repeater, such that the focus or orientation of the magnetic flux is enhanced. This configuration will also allow the magnetic flux to travel further and the distance between the transmitter and receiver coils can be increased.

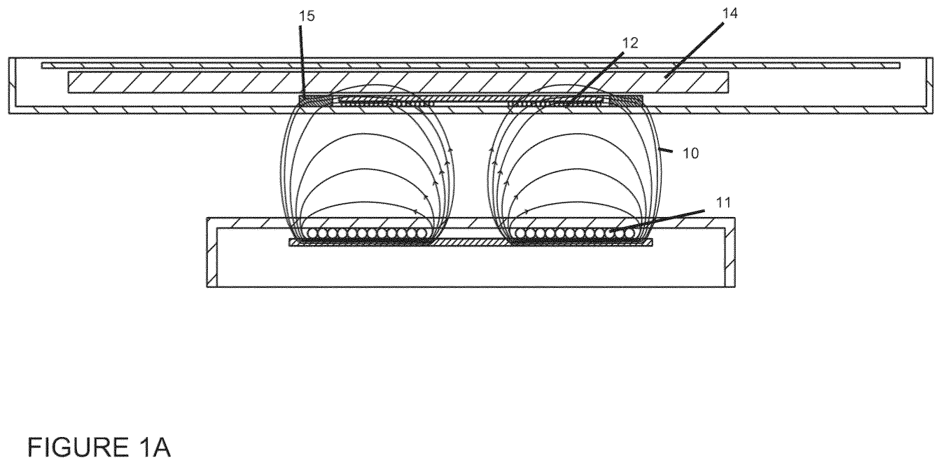

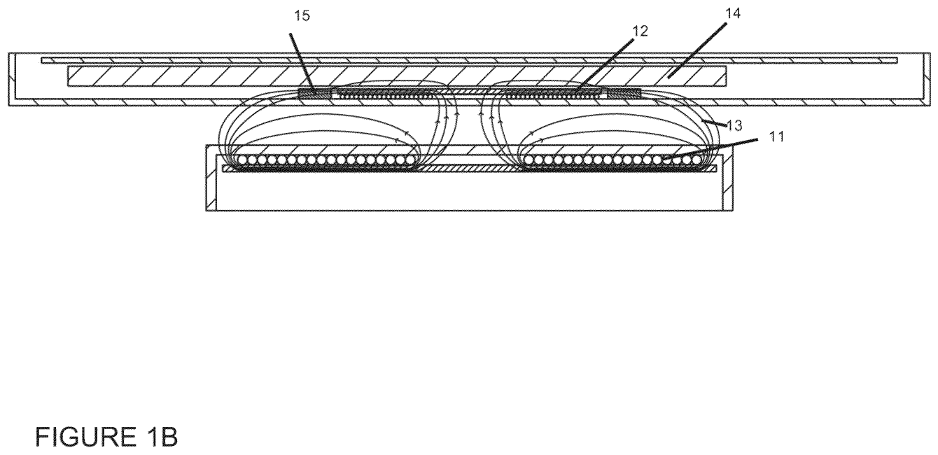

FIGS. 1A and 1B show cross-sections of an inductive wireless charging system comprising a transmitter coil 11 and a receiver coil 12. The illustrated wireless charging system does not include a shield or screen. A representation of the dispersion of the magnetic field 10, 13 is shown for the case in which the transmitter coil and receiver coils are separated by a large distance such as 30 mm (FIG. 1A), and for the case in which the transmitter coil is significantly larger than the receiver coil (FIG. 1B). The figures also show additional elements that may surround the receiver coil such as a battery (14) or permanent magnets (15).

As shown, some undesirable magnetic field lines are present on sensitive components of the receiver device, such as the battery.

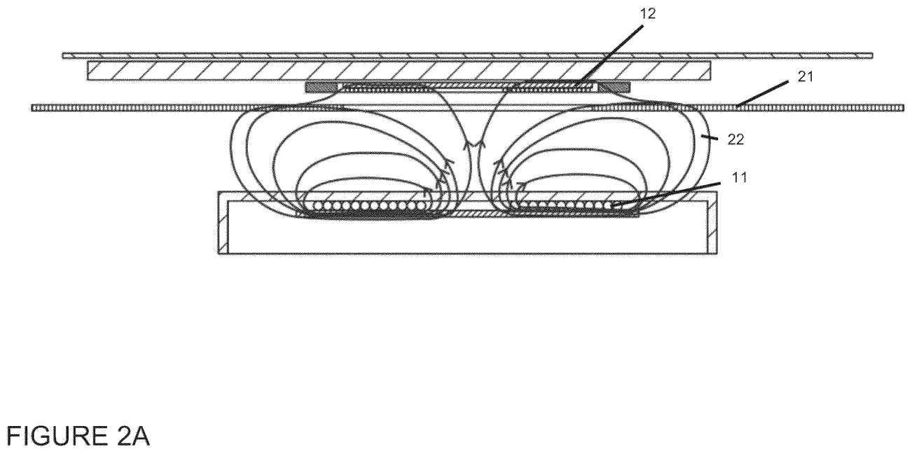

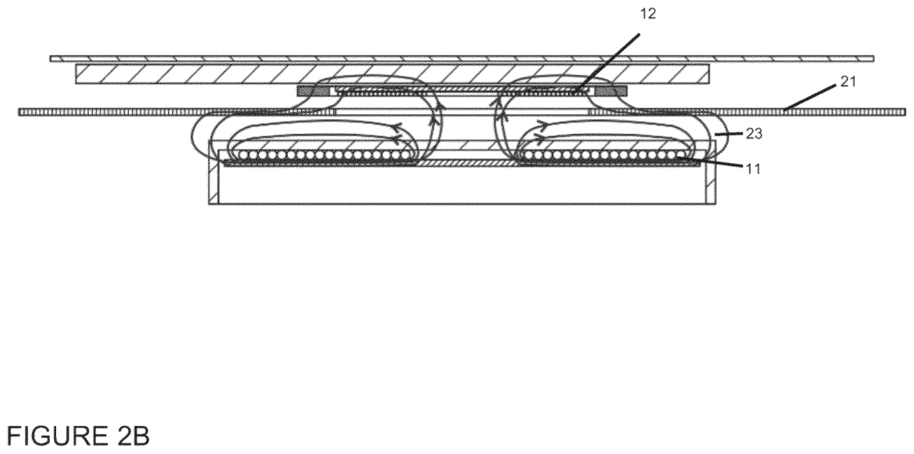

As a comparison, FIGS. 2A and 2B show cross sections of an inductive wireless charging system comprising a transmitter coil 11, a receiver coil 12 and a shield 21. A representation of the dispersion of the magnetic field 22, 23 is shown for the case in which the transmitter coil and receiver coils are separated by a large distance (FIG. 2A), and for the case in which the transmitter coil is significantly larger than the receiver coil (FIG. 2B). The shield is located, generally, in between the transmitter coil and receiver coil.

The shield 21 includes a soft ferrite, with low hysteresis, high resistivity and a relative permeability of at least 150 and up to 2000 as an example. The shield is configured to orient the magnetic flux generated by the transmitter coil onto the receiver coil, while keeping the power losses extremely low. As shown, the undesirable magnetic field lines on sensitive components of the receiver device have been greatly reduced.

Preferably, the high magnetic permeability material is a thin sheet or layer made of soft ferrite.

Preferably, the shield is lightweight with a thickness ranging from 0.1 mm to a few millimetres.

Preferably, the shield includes at least a cavity or hole.

The receiver coil is configured to provide electrical energy to a rechargeable battery. The receiver coil may be implemented in a portable electronic device or vehicle or light.

Several configurations of the wireless charging system are now described.

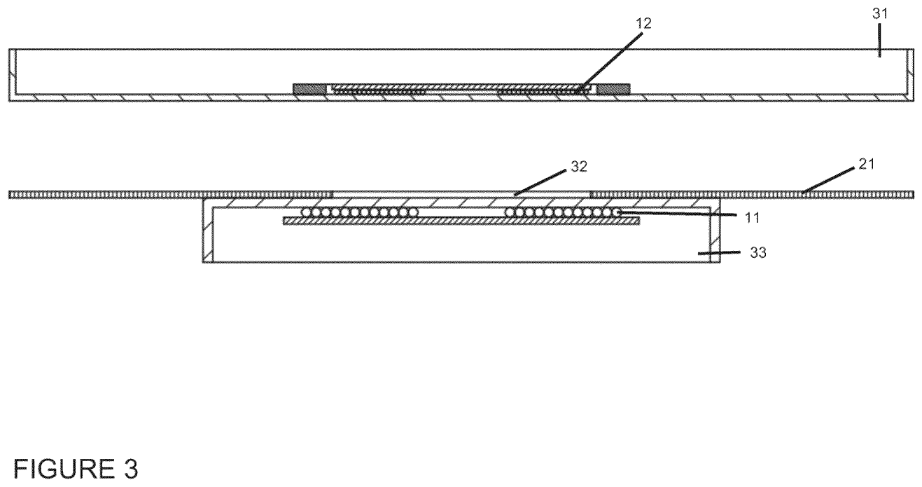

FIG. 3 shows the receiver coil 12 integrated in a portable electronic device 31. The shield 21 includes a hole or cavity 32 and is located between the transmitter device 33 including the transmitter coil 11 and the portable electronic device. In this particular example, the shield is located directly on top of the transmitter device.

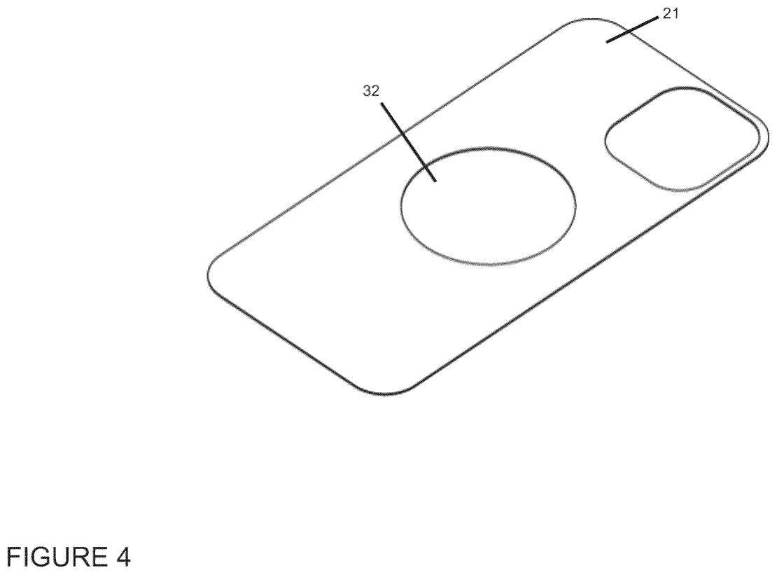

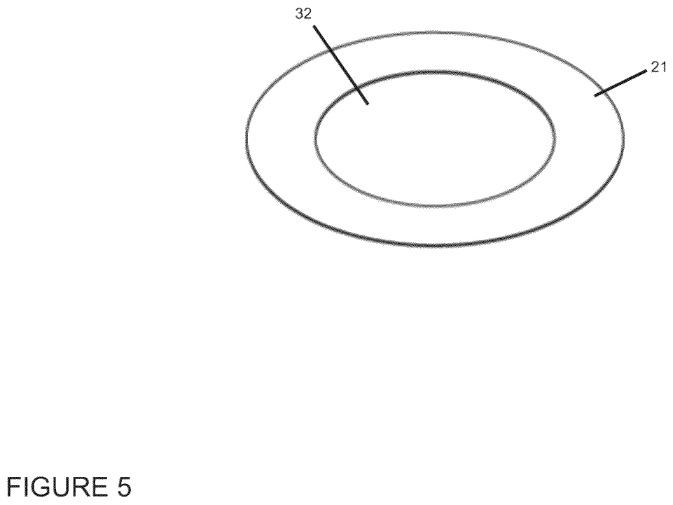

FIGS. 4 and 5 show different shapes of a shield configured to be located between a transmitter coil and a receiver coil. The shield 21 includes at least a cavity or hole 32 that is shaped to have dimensions substantially equal to the outer diameter of the receiver coil. The exact dimension of the hole is tuned according to the main geometrical parameters of the wireless charging system, such as, but not limited to: distance between the transmitter coil and receiver coil, distance between the shield 21 and receiver coil, size of transmitter and receiver coils, and any presence of magnets around the transmitter or receiver coils.

One objective of the shield is to confine the magnetic flux coming from the transmitter coil, so that it couples just with the receiver coil winding, and not with surrounding elements, such as magnets, batteries, or other components subject to overheating.

The hole 32 diameter is optimised in order to correspond to the best compromise between the coils' coupling and critical components screening such that the wireless charging system provides a minimum charging time. Alternatively, the cavity or hole may also take other shapes, such as rectangular or hexagonal. The shape of the cavity 32 may be customised depending on the wireless charging system parameters.

As shown in FIG. 4, the shield 21 may cover the entire shape of a portable electronic device, excluding protruding elements such as cameras, flash lamps, LEDs, or buttons. This configuration allows the maximum screening of the components inside the portable electronic device, apart from the coils.

In addition, if the screen covers the whole device area, its broad extension can ease thermal dissipation of residual losses on the soft ferrite itself, caused by small yet non-negligible eddy currents.

As shown in FIG. 5, the shield 21 may have a ring shape in order to shield a reduced portion around the receiver coils, for instance magnets located around or behind the receiver coil. This configuration allows for reducing the amount of ferrite needed and also for reducing the cost of the shield.

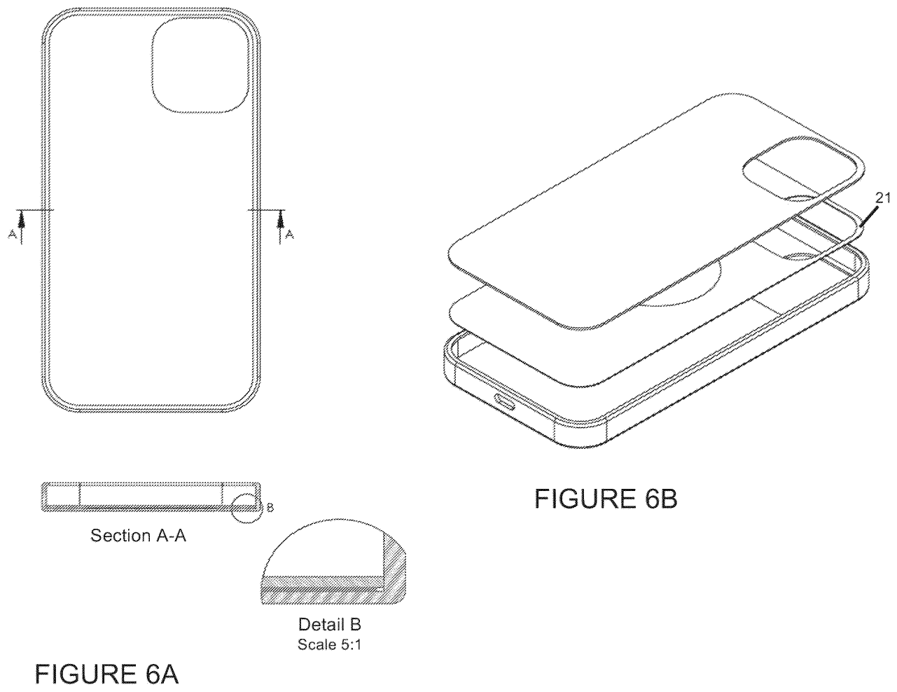

The shield 21 may be located in between the portable electronic device, such as a phone, and its case or accessory. The shield, as shown in FIG. 4, can be integral to the case or accessory or an additional part that is easily inserted and removable from the case itself, as shown in FIGS. 6A and 6B (section view and exploded view). In this configuration, the ferrite shield 21 is beneath the layer of the cover, directly facing the portable electronic device surface.

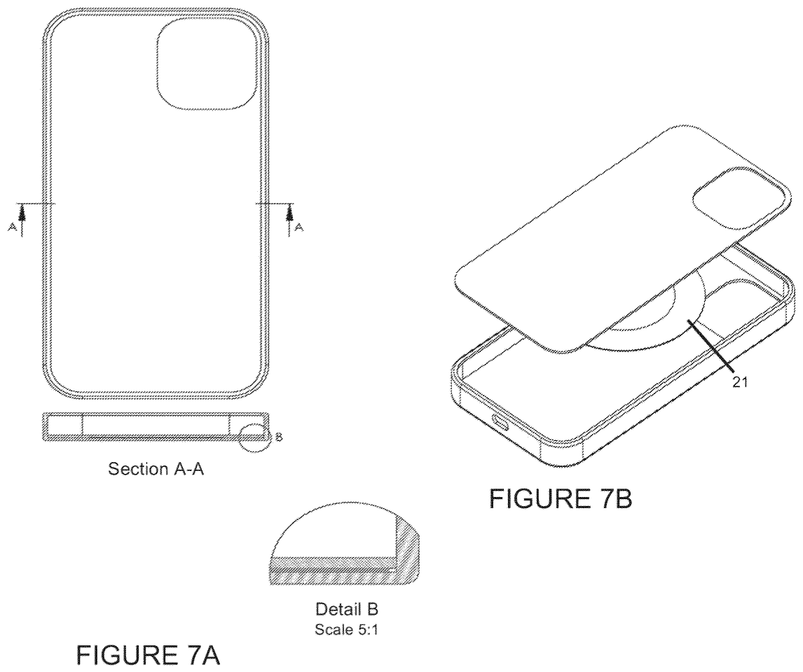

FIG. 5 shows a shield that can be directly integrated within the case of the portable electronic device or attachable and removable from the case itself, as shown in FIGS. 7A and 7B (section view and exploded view).

Alternatively, the shield may be attachable and removable from the top of the case or accessory.

Alternatively the shield may be directly integrated inside the portable electronic device itself, and may be located in front of the receiver coil, such that the magnetic field generated by the transmitter coil reaches the shield before the receiver coil.

Alternatively, the material of the portable electronic device cover may be directly made with magnetic properties. For this, a specific fabrication process is followed.

Indeed, common ferrite sheets are made of ferromagnetic powders (made of Ni, Fe, Mn, Zn or Cd, for instance) whose grains are kept together by a resin. These grains undergo transformation phases with increasing pressure and temperature, to get the desired particle size and density within a foil. The resulting relative percentage of ferrite grains and resin sets the final magnetic properties of the ferrite sheet, with magnetic permeability increasing with ferrite concentration.

The resin can also be substituted with melted plastic, flexible polymers, rubber, silicone, or any other material used to fabricate device covers, with the ferromagnetic powders directly dispersed into it. Then, such a mixture, after proper stabilisation phases, can be injected into a mould, where it solidifies into the desired accessory shape. Depending on a number of parameters, such as particle mobility, solidification time and spatial orientation of the mould, the ferrite powder can be dispersed in an inhomogeneous way, thus providing a gradual variation of the magnetic permeability across the magnetic shield itself. Advantageously this results in a relatively smooth bending of the magnetic field lines when travelling across the device cover.

Alternatively, multi-shot injection moulding can be used to obtain different ferromagnetic properties or shielding capabilities in different portions or areas of the cover, with high contrast or discontinuities in the magnetic permeability between adjacent areas. In other words, different ferrite subparts can be selected and combined together, with any shape and in a very controlled way, to have a more severe bending of the magnetic field lines. For instance, a completely non-ferromagnetic plastic region can stay in contact with a high-permeability area, with the former repelling the magnetic field and helping to focus the magnetic field just in latter. The hole or cavity of the shield may also be filled using a material that is non-magnetic.

The implementations described above provide configurations in which the shield is aligned with the receiver coil. In particular the hole or cavity of the shield is shaped based on the diameter of the receiver coil. The custom shield therefore is beneficial for the wireless power transfer, as it substantially targets the magnetic flux on the receiver coil and prevents undesired magnetic field to reach sensitive components that are likely to heat up inside the device under charge such as batteries or permanent magnets. Indeed, the generation of heat may often trigger overtemperature protections in the charge algorithm, which may lower the power requested by the receiver or even stop the charge, leading to an increased charging time.

Conversely, magnetic field confinement also translates into lower thermal stress on the internal components of the device under charge, such as the frame or battery as well as on high-hysteresis ferromagnetic components such as permanent magnets.

As a consequence, the power delivered to the portable electronic device may be kept at a high level during the entire charging process. This results in an improved charging speed with the additional shield.

As an alternative, the shield can be attached to the charger or transmitter device itself. The wireless charging system may then be improved for the following cases: (i) great geometrical mismatch between transmitter and receiver coils, (ii) great distance between coils, and/or (iii) presence of magnets.

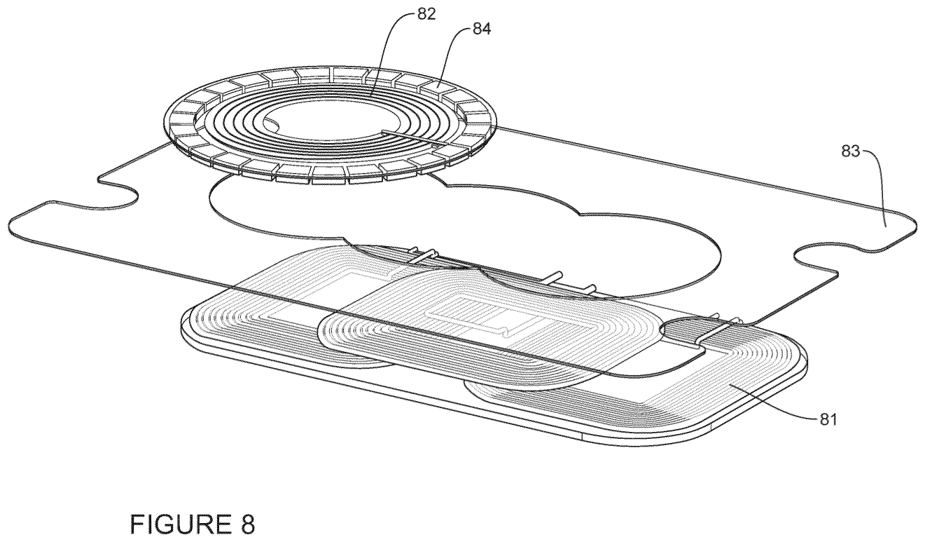

FIG. 8 illustrates a possible implementation of a shield that is configured to be aligned or attached to the charger. The wireless charging system includes a triple coil charger 81, a receiver coil 82 and a shield 83. Magnets 84 are also surrounding the receiver coil. The shield is configured to stay in a fixed position in relation to the charger, includes a cavity or hole that provides a tradeoff between magnetic shielding or screening and accessibility of each of the three coils.

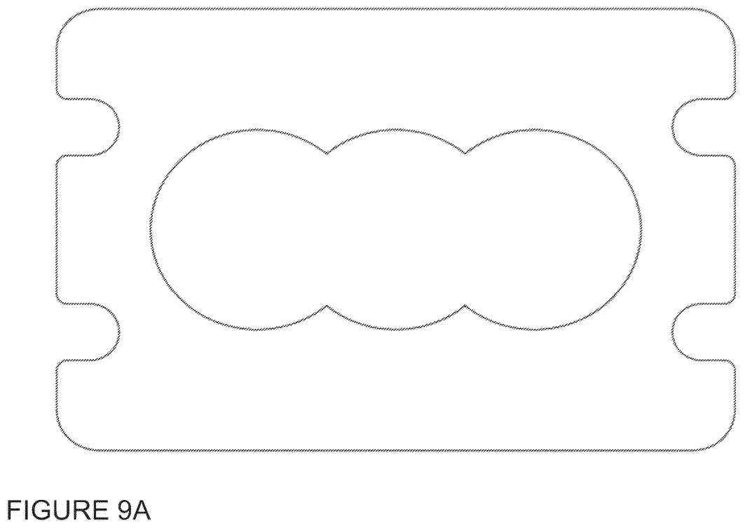

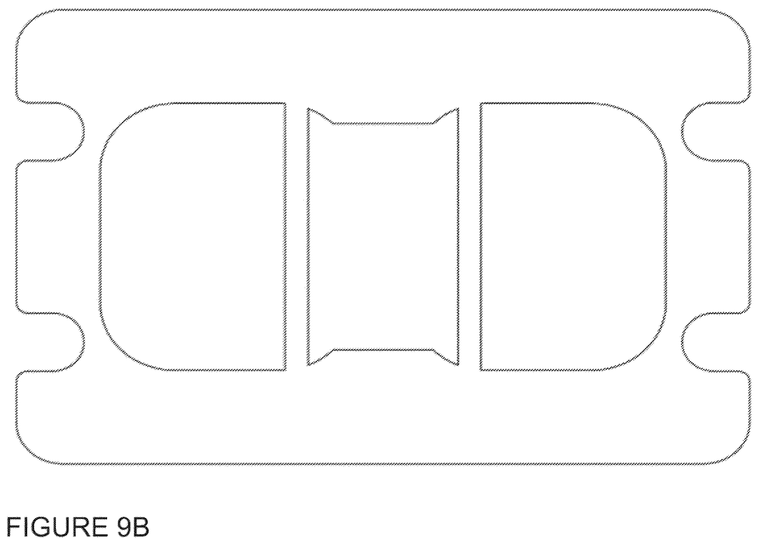

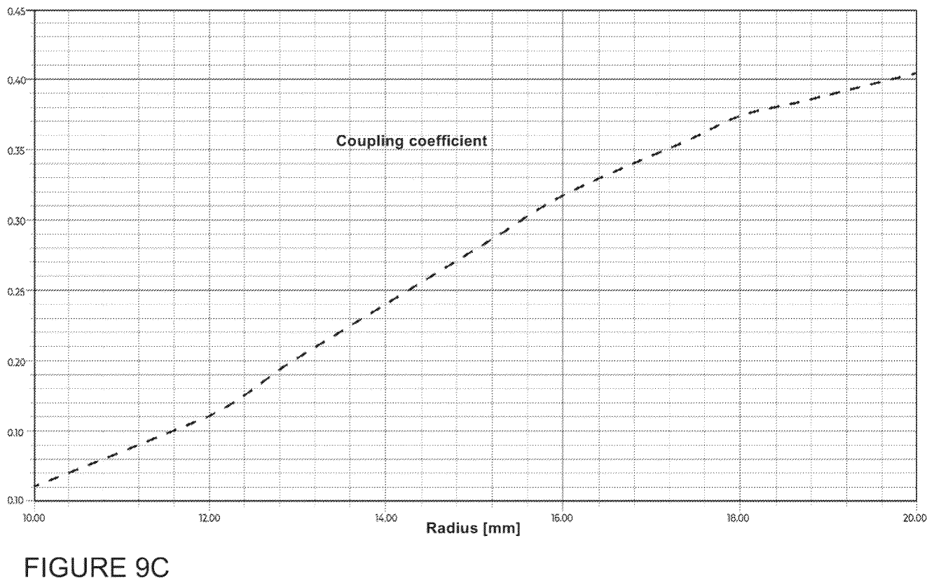

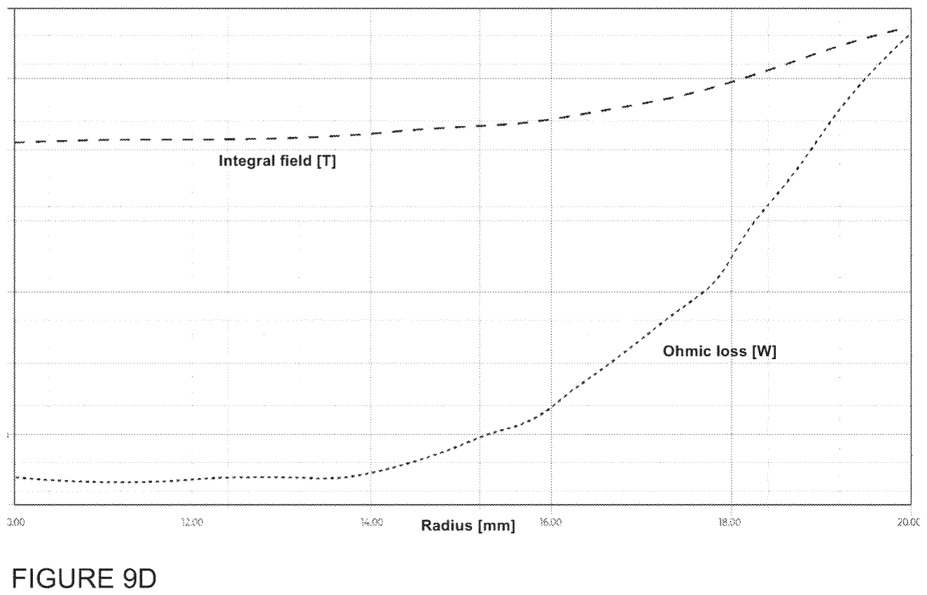

FIG. 9A shows the top view of the shield of FIG. 8. Many configurations are possible for a shield that can be configured to orient the magnetic flux of a triple coil transmitter coil. As another example, FIG. 9B shows the top view of another configuration for the shield that includes three cavities or holes.

The shape of the hole or holes is determined based on the parameters of the wireless charging system, including the geometry of the transmitter and receiver coils, the distance between the transmitter and receiver coils, the positioning of the receiver coil with respect of the transmitter coils as well as the power to be delivered.

The shape of the hole or holes may also be optimised by performing electromagnetic simulations. As an example, the shield in FIG. 9A is parameterized with respect to the radius R of each sub-hole with each sub-hole component having the same radius R.

FIG. 9C shows a plot of the coupling coefficient k between the transmitter and receiver coils as a function of varying the radius R. This is used to determine or quantify the minimum k such that the wireless power transmission is effective. On the other hand, FIG. 9D shows a plot of ohmic or resistive losses on the magnets (84 in FIG. 8) and the magnetic field hitting the magnets as a function of varying the radius R. This provides a quantification of the screening capability of the shield with an upper limit for the maximum tolerated value of the field on the magnets.

Using this example, the optimum size of the radius R is determined to be 18 mm, corresponding to a mutual coupling coefficient k of about 0.37.

In this configuration, the magnetic flux generated by a single transmitter coil may not be confined in all directions, due to the partial overlap between the transmitter coils.

In order to compensate for this issue, a movable shield with a single hole or cavity corresponding to the overall diameter of one transmitter coil may be used, as an alternative to the triple-hole screen. The shield may be placed on rails located inside the transmitting device itself. Such a screen can be moved and positioned above the single-activated coil, on the basis of the relative position of the receiving device.

Alternatively, the shield may also include or be integrated as part of a repeater device, including two electrically connected coils. This shield may be referred to as ‘integrated coils screen’. As described above, the shield is then located between a charger including a transmitter coil and a receiver device including a receiver coil.

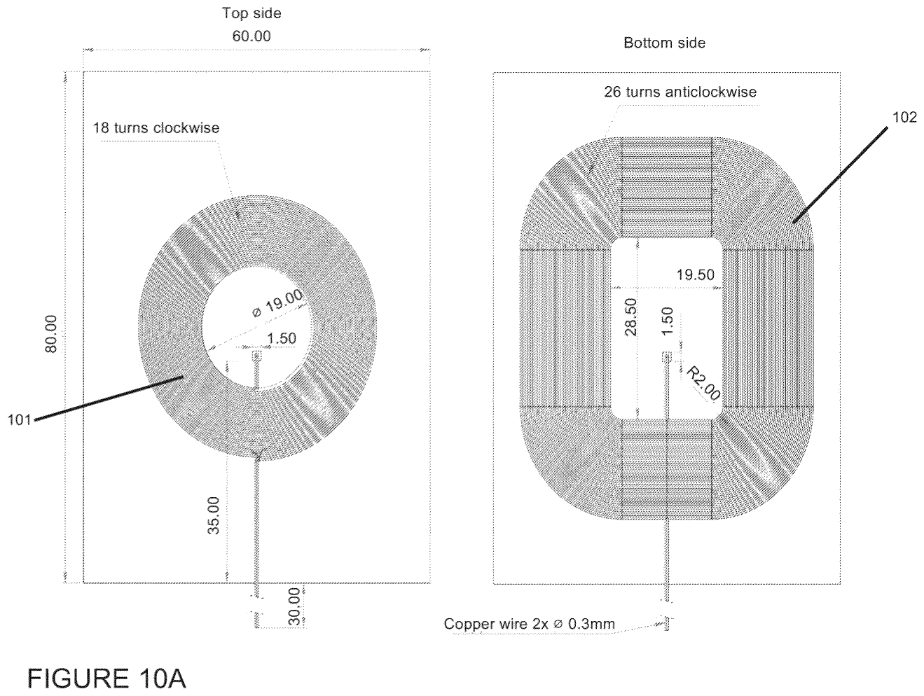

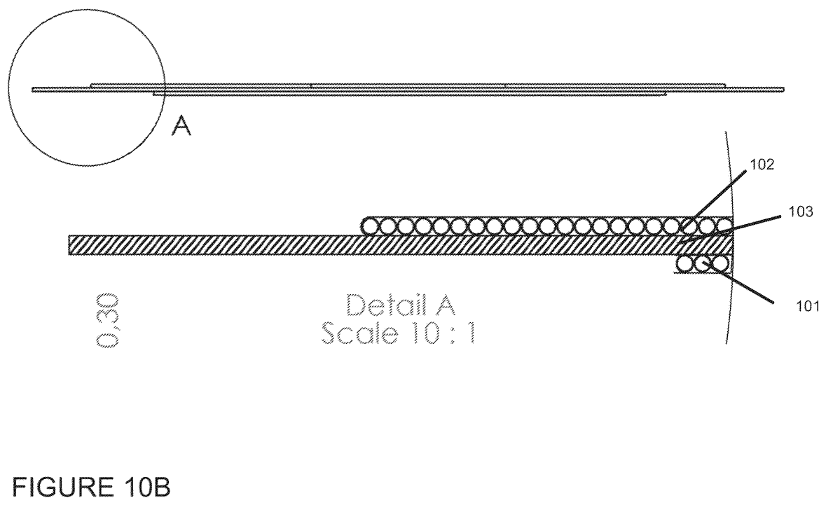

As an example, FIGS. 10A and 10B show a repeater device with two electrically connected and vertically aligned coils.

In particular, the first coil 101 of the repeater device facing the charger is shaped or otherwise configured in order to collect the maximum amount of magnetic flux coming from the transmitter coil of the charger, at a specific distance range. The second coil 102 of the repeater device is shaped or otherwise configured to substantially match the shape of the receiver coil and is configured to transfer a maximum amount of magnetic flux to the receiver coil of the receiver device.

Hence the ‘integrated coil screen’ is configured to reshape or orient the magnetic field coming from the transmitter coil into a spatial distribution that is more suitable for maximum coupling with the receiver coil. A thin layer or sheet of ferrite 103 is placed in between the first and second coils of the repeater device, to provide magnetic insulation between the two sides of the magnetic coupling system. As a consequence, this ferrite may only have minor holes in the neighbourhood of coils' axis.

The ‘integrated coil screen’ maximises the magnetic flux collected from the charger and rearranges it in a spatial shape more suitable for the repeater. Conversely, the simple ferrite layer stops the undesired magnetic flux, which is then dispersed in the gap between the transmitter coil and receiver coil. As an effect, the shield provides a higher coupling efficiency between transmitter and receiver, and as a result a lower resulting thermal dissipation.

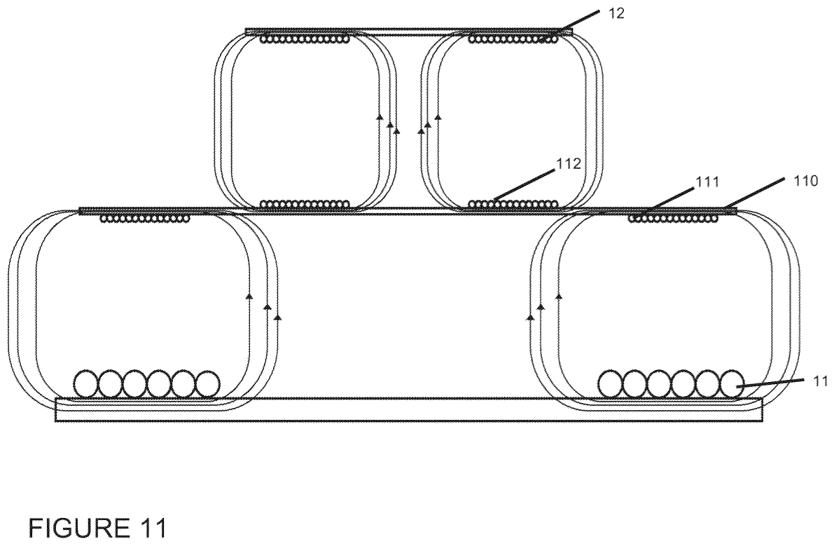

FIG. 11 shows a representation of the magnetic field lines when the ‘integrated coil screen’ 110 is located between a transmitter coil 11 and receiver coil 12. The space is ideally split into two by a ferrite layer located in between the lower (or first) 111 and upper (or second) 112 coils of the repeater: the two magnetic field distributions look significantly different in terms of their spatial distribution.

The repeater coils may for example be fabricated on a PCB or made of a simple wire (e.g. double wire) or a combination of both. The integrated-coils screen may have a total thickness of about one millimetre.

In particular, wire winding represents a highly consolidated technique, especially for the fabrication of receiver coils, which can reach a significantly low thickness thanks to wires in the order of a few tenths of millimetre. Due to very strict tolerance requirements, handling copper in a serially-manufactured way requires a tooling customised for the coil geometry, as both wire position and tension need to be under control during the winding process.

Conversely, PCB coils provide higher flexibility in the pattern of the coils, either in terms of the overall shape of the coil, such as round, circular or hexagonal, as well as interweaving tracks, such as single-layer multi strand, multi-layer, or Litz-wire like pattern. While PCB coils have higher internal DC resistance and lower efficiency, they are characterised by significantly lower thickness and cost.

The connection between the two coils may be made via traditional heat-based soldering, or via thermo-pressure bonding, which is particularly effective in case of ultra-fine wires connected to PCB.

As an additional variant, metal parts, such as the conductive coils, can be directly plated on the ferrite shield, in order to minimise the total thickness of the shield.

In order to further reduce fabrication effort in directly handling ferrites while printing the coil, a flexible substrate may also be used, such as a pcb, that is then placed around the ferrite shield. A combination of conductive plated coils and coils printed on a flexible pcb and soldered to the plated coils may also be used.

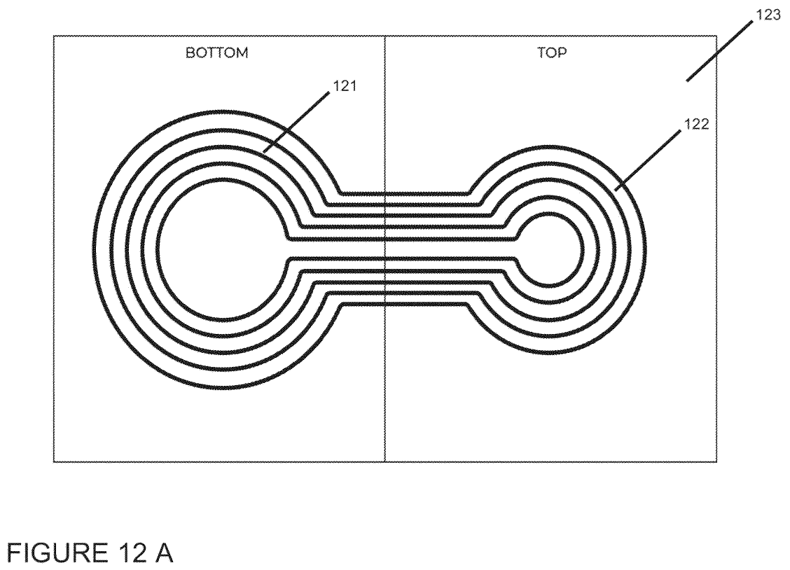

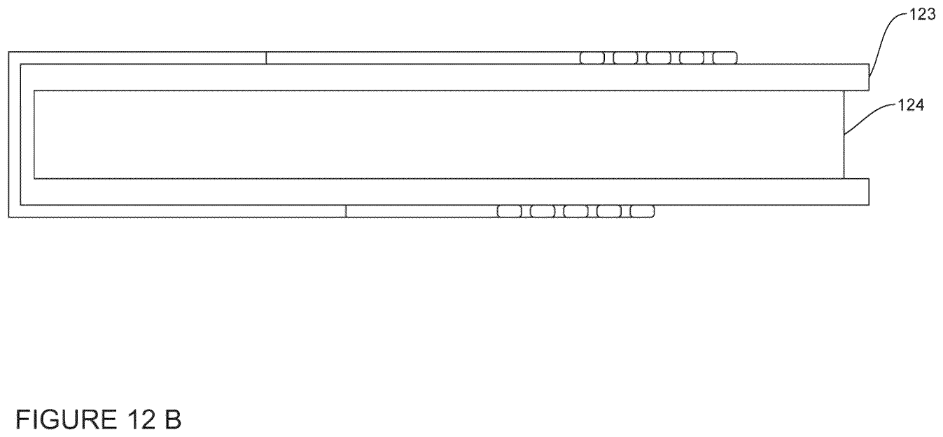

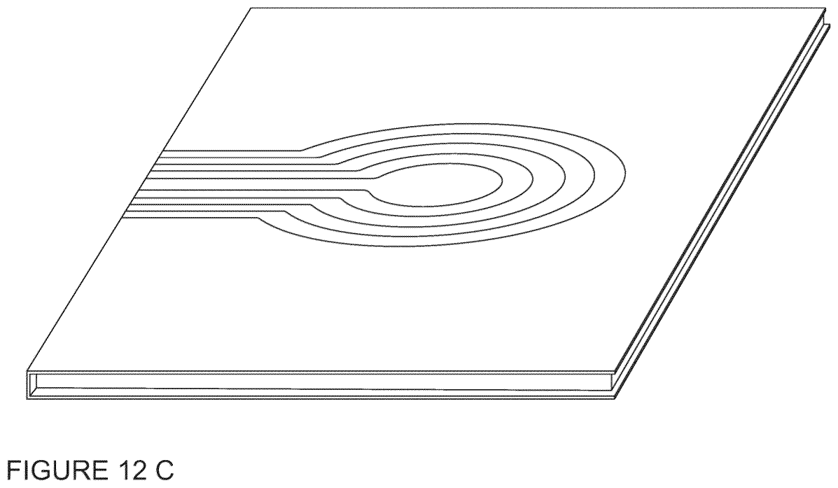

FIG. 12 shows another configuration for the shield including a sheet of soft ferrite and a repeater device. FIG. 12A shows the components of the repeater device including a receiver coil or first coil 121 and a transmitter coil or second coil 122. The two coils of the repeater device are respectively located on the top layer of a substrate or PCB 123. The substrate or PCB is made of a flexible material and is then folded such that the two coils of the repeater device are located on each side of the folded substrate 123. FIG. 12B shows a side view of the shield including the sheet of soft ferrite 124 and the repeater device located on the folded substrate. The sheet of soft ferrite is therefore located in between the first coil and second coil of the repeater device. FIG. 12C shows an isometric view of the shield.

The pattern made by the coils of the repeater device is planar and can be obtained using a plating process, which is easily controlled and versatile as well as cost effective.

In this case, a concentric arrangement of the windings of each coil is used to achieve a planar structure, in which the innermost winding of the receiving coil forms a closed mesh with the innermost winding of the transmitting ones. This one-to-one connection also provides all the back and forth connections, and assumes the two coils have the same number of windings.

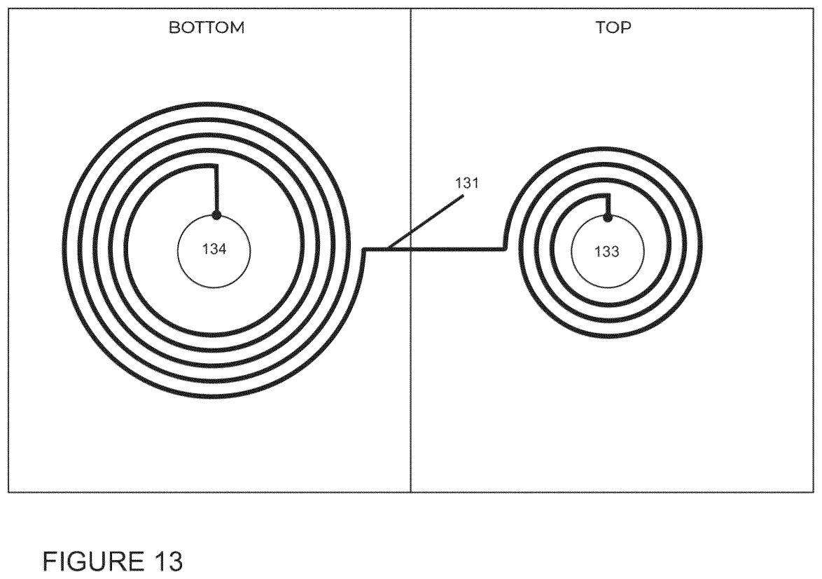

Alternatively, a spiral-like coil pattern may be achieved for example by: (i) multilayer PCB drawing of the tracks, with vias traversing the substrate in a transversal way, or (ii) adding a hole or pathway to connect the two coils together when the substrate is folded, as shown in FIG. 13.

FIG. 13 shows the first coil and second coil of the repeater device (when the substrate has not yet been folded). The two coils exhibit a spiral geometry, with one electrical connection 131 that goes from one side of the foil or substrate to the other side in a planar way. The two coils also have a galvanic connection provided via the holes 133 134 providing a closure for the electrical loop when the substrate is folded. In this case the ferrite foil placed in between has to have an hole too, to allow the galvanic connection.

The ‘integrated coil screen’ may be attachable and removable from an accessory of the receiver device such as a case or cover, or directly integrated within the accessory.

As an alternative, in case of a shield located directly near or attached just above the transmitter device, the shield may be fabricated in the form of a mat, with any outer shape. Additionally, the shield itself may also include an alignment mechanism, such as a few magnets with axial-symmetric arrangement (for instance, a circular crown) with a size comparable to the magnets crown located inside a phone. This enables an optimum relative positioning of the shield and the receiver coil.

With this arrangement, the mat may include a soft outer case, for instance made of plastic, to avoid wear on both screen and device under charge.

Diaphragm Implementation

The hole or cavity of the shield may also have a variable diameter adjusted by the means of a diaphragm-like mechanism.

This allows to dynamically adapt the shape of the shield to the dimension of the receiver coil, overcoming the limitation of a rigid custom-cut design, thereby enhancing the performance of the wireless charging system.

Hence the shield may be adapted to any possible portable electronic device model. The shape of the cavity may be varied based on the distance between transmitter and receiver coils.

The diameter of the cavity may be varied using an adjustment mechanism located outside or near the shield.

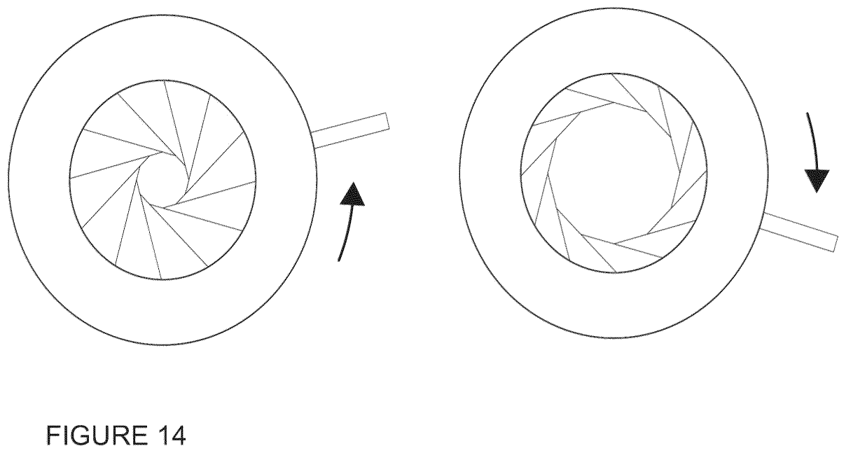

The adjustment mechanism may either include a manual slider (see FIG. 14) or may be electronically implemented, for instance via a piezo-electric actuator.

Receiver Optimization

As highlighted above, hard-ferromagnetic components located inside the device under charge represent an “attractive” element for the dispersion of the magnetic field, due to their high magnetic hysteresis.

For instance, in the case of the permanent magnets located just beneath the case of a portable electronic device such as a phone, the magnetic field is forced to curve and go through them. Since they are metallic, such magnets tend to overheat under the action of the magnetic field, leading to a risk of temperature rise also in the surrounding regions of the phone: as a consequence, the power management algorithms of the phone limit the wireless charging speed.

Conversely, the addition of magnets to the phone structure is meant to be beneficial for the wireless charging performances, as they provide a better alignment between transmitting and receiving coils; in addition, they are useful also to improve the stability of extra accessories attached to the phone itself.

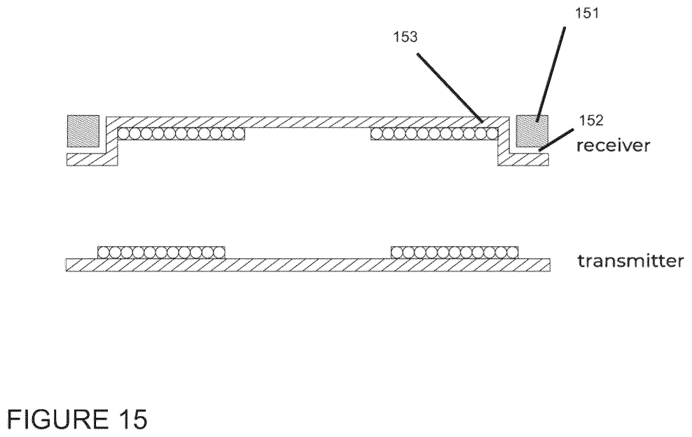

FIG. 15 shows another configuration of the shield for a wireless charging system. The receiver device includes permanent magnets 151 which are moved towards the interior of the receiver device and are separated by a small air gap 152 from the ferrite shield 153. The shield is then bent in order to follow the magnets' profile at the outer ends and to leave space for the positioning of the receiver coil at its centre.

In this configuration, the magnetic field is prevented from scattering into the permanent magnets, thanks to the air gap which opposes the formation of a magnetic path thanks to its poor magnetic permeability; on the other hand, the permanent magnets are still close enough to the phone surface in order to provide the self-alignment effect.

In this arrangement the ferrite shield has no holes, since it acts as a magnetic barrier for the device inner elements that surround the receiving coil.

### APPENDIX

The key features are now generalised. We also list various optional sub-features for each feature. Note that any feature can be combined with one or more other features, including all the features or sub-features.

Key Feature A—Shield for a Wireless Charging System

A shield for a wireless charging system including a transmitter coil and a receiver coil, in which the shield includes a thin sheet or layer made of soft or nanocrystalline ferrite and in which the shield is a) partly located, in use, between the transmitter coil and the receiver coil, and b) shaped or otherwise configured to focus or orient a magnetic flux generated by the transmitter coil onto the receiver coil.

Generally applicable optional features:
The shield is entirely located, in use, between the transmitter coil and receiver coil.
Sheet of soft ferrite includes a cavity or hole.
Cavity or hole has a diameter substantially equal to the outer diameter of the receiver coil.
Cavity or hole is made of a material with low relative magnetic permeability, such as a relative magnetic permeability of 1.0.
Shield is configured to shield one or more magnets located around or behind the receiver coil and/or transmitter coil.
Shield has a ring shape.
Receiver coil is configured to provide electrical energy to a rechargeable battery and is implemented in a portable electronic device, vehicle, light etc.
Shield has generally the same shape as a base of the portable electronic device.
Shield includes holes corresponding to the receiver coil location and to protruding elements of the portable electronic device.
Shield is configured to shield a battery located behind or near the receiver coil.
Shield is configured to automatically align to a permanent magnet surrounding or partially surrounding the receiver coil and/or the transmitter coil.
Shield is configured to adjust its position based on the measured coupling between the transmitter coil and receiver coil.
Shield includes alignment mechanisms, such as rails.
Diameter of the transmitter coil is substantially higher than the diameter of the receiver coil.
Sheet of soft ferrite has a bent portion to provide space for permanent magnets located near the receiver coil and/or transmitter coil.
Sheet of soft ferrite has a thickness of less than 0.1 mm, 0.3 mm or less than 0.5 mm.
Sheet of soft ferrite has a thickness of less than 1 mm.
Sheet of soft ferrite is made of multiple layers of ferrite.
Sheet of soft ferrite is made of a combination of different kinds of ferrite material (i.e with different ferromagnetic properties).
The different kinds of ferrite material are configured to provide a gradual variation of the magnetic permeability across the shield.
Ferrite material includes ferromagnetic powders, in which the ferromagnetic properties are based on grain powder size and/or density.
Ferrite material includes a binder such as resin, melted plastic, flexible polymer, rubber, silicone or any other materials used to fabricate portable electronic device cover or case.
Multi-shot injection moulding is used to obtain different ferromagnetic properties or shielding capabilities in different portions or areas of the shield.

Key Feature B—Shield Includes a Cavity with Varying Diameter

A shield for a wireless charging system including a transmitter coil and a receiver coil, in which the shield includes a thin sheet or layer made of soft or nanocrystalline ferrite located, in use, between the transmitter coil and the receiver coil and that is shaped or otherwise configured to focus or orient a magnetic flux generated by the transmitter coil onto the receiver coil;
and in which the shield includes a cavity with a varying diameter.

Optional features:
Diameter of the cavity is varied based on the outer diameter of the receiver coil.
Diameter of the cavity is varied based on the distance between transmitter and receiver coils.
Cavity diameter is varied using an adjustment mechanism.
Adjustment mechanism is located outside or near the shield.
Adjustment mechanism includes a manual slider.
Adjustment mechanism is electronically implemented.

Key Feature C—Shield Including a Repeater System

A shield for a wireless charging system including a transmitter coil and a receiver coil, in which the shield includes a thin sheet or layer made of soft or nanocrystalline ferrite located, in use, between the transmitter coil and the receiver coil and that is shaped or otherwise configured to focus or orient a magnetic flux generated by the transmitter coil onto the receiver coil,
and in which the shield further includes a repeater system including two electrically connected coils, and in which the thin sheet or layer of ferrite is located in between the two electrically connected coils.

Optional features:
The first coil of the repeater system has dimensions similar to the dimensions of the transmitter coil.
The second coil of the repeater system has dimensions similar to the dimensions of the receiver coil.
The electrically connected coils are planar coils fabricated on a PCB or wire wound or a combination of both.
The shield further includes permanent magnets.
The two coils are located on the same layer of a flexible substrate and in which the flexible layer is then folded around the sheet of ferrite.
The windings of the coil have a concentric arrangement or a spiral pattern.
The substrate and the sheet of soft ferrite include a hole to allow galvanic connection between the coils.

Key Feature D—Wireless Charging System

A wireless charging system comprising:
(a) a transmitter coil configured to generate a magnetic flux;
(b) a receiver coil configured to receive the generated magnetic flux;
(c) a magnetic shield partly located between the transmitter coil and the receiver coil;
   in which the shield is shaped such as to focus or orient a magnetic flux generated by the transmitter coil onto the receiver coil.

Key Feature E—Accessory for a Portable Electronic Device

Accessory for a portable electronic device including a receiver coil configured to provide electrical energy to a rechargeable battery, in which the accessory system includes a shield,
in which the shield includes a thin sheet or layer made of soft or nanocrystalline ferrite that is shaped or otherwise configured to focus or orient a magnetic flux generated by a transmitter coil.

Optional features:
Sheet of soft ferrite is made of multiple layers of ferrite.
Sheet of soft ferrite is made of a combination of different kinds of ferrite material (i.e with different ferromagnetic properties).
The different kinds of ferrite material are configured to provide a gradual variation of the magnetic permeability across the shield.
Ferrite material includes ferromagnetic powders, in which the ferromagnetic properties are based on grain powder size and/or density.
Ferrite material includes a binder such as resin, melted plastic, flexible polymer, rubber, silicone or any other materials used to fabricate portable electronic device accessory or cover or case.
Multi-shot injection moulding is used to obtain different ferromagnetic properties or shielding capabilities in different portions or areas of the accessory.
Accessory is integral to a case for the portable electronic device.
Accessory is attachable and removable from a case for the portable electronic device.
Accessory is located between the transmitter coil and device cover.
Accessory has an alignment system between charger and device.
Accessory integrates magnets with axial-symmetric positioning.
The magnets in the accessory are arranged on a crown.
Sheet of ferrite includes a cavity or hole.
Accessory integrates two electrically connected coils.
Sheet of ferrite is located in between the two electrically connected coils.

Key Feature F—Accessory for a Wireless Power Charger

Accessory for a wireless power charger including a transmitter coil configured to provide electrical energy to a receiver coil that is located inside a portable electronic device, in which the accessory system includes a shield,
in which the shield includes a thin sheet or layer made of soft or nanocrystalline ferrite that is shaped or otherwise configured to focus or orient a magnetic flux generated by the transmitter coil onto the receiver.

Optional features:
Accessory is integral to the wireless power charger.
Accessory is attachable and removable from the wireless power charger.
Sheet of ferrite includes a cavity or hole.
Sheet of ferrite has a mechanism to adapt hole size.
Sheet of ferrite moves on a sliding mechanism.
Accessory has an alignment system between charger and device.
Accessory integrates magnets with axial-symmetric positioning.
The magnets in the accessory are arranged on a crown.
Accessory has a soft material enclosure, like rubber, plastic or fabric.

Key Feature G—Portable Electronic Device Including a Thin Layer of Soft Ferrite

Portable electronic device including a receiver coil configured to provide electric energy to a rechargeable battery and a shield,
in which the shield includes a thin sheet or layer made of soft or nanocrystalline ferrite that is shaped or otherwise configured to focus or orient or confine a magnetic flux generated by a wireless transmitter coil onto the receiver coil.

Optional features:
A portion of the ferrite sheet is located above the receiver coil.
The ferrite sheet includes bent portions.
The ferrite sheet separates the coil from magnets located inside the portable electronic device.
Spacing or air gap is present between the ferrite sheet and magnets located inside the portable electronic device.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A shield for a wireless charging system including a transmitter coil and a receiver coil, in which the shield includes a thin sheet or layer made of soft or nanocrystalline ferrite, and in which the shield is a) partly located, in use, between the transmitter coil and the receiver coil, and b) shaped or otherwise configured to focus or orient a magnetic flux generated by the transmitter coil onto the receiver coil, characterized in that the sheet of soft ferrite includes a cavity or hole.

2. The shield of claim 1, in which the shield is entirely located, in use, between the transmitter coil and receiver coil.

3. (canceled)

4. The shield of claim 1, in which the cavity or hole has a diameter substantially equal to the outer diameter of the receiver coil.

5. The shield of claim 1, in which the cavity or hole is filled with a material with low relative magnetic permeability, such as a relative magnetic permeability of 1.0.

6. The shield of claim 1, in which the shield is configured to shield one or more magnets located around or behind the receiver coil and/or transmitter coil.

7. The shield of claim 1, in which the shield has a ring shape.

8. The shield of claim 1, in which the receiver coil is configured to provide electrical energy to a rechargeable battery and is implemented in a portable electronic device.

9. The shield of claim 8, in which the shield has generally the same shape as a base of the portable electronic device.

10. The shield of claim 8, in which the shield includes holes corresponding to the receiver coil location and to protruding elements of the portable electronic device.

11. The shield of claim 9, in which the shield is configured to shield a battery located behind or near the receiver coil.

12. The shield of claim 1, in which the shield is configured to automatically align to a permanent magnet surrounding or partially surrounding the receiver coil and/or the transmitter coil.

13. The shield of claim 1, in which the shield is configured to adjust its position based on the measured coupling between the transmitter coil and receiver coil.

14. The shield of claim 1, in which the shield includes alignment mechanisms, such as rails.

15. The shield of claim 1, in which the diameter of the transmitter coil is substantially higher than the diameter of the receiver coil.

16. The shield of claim 1, in which the sheet of soft ferrite has a bent portion to provide space for permanent magnets located near the receiver coil and/or transmitter coil.

17. The shield of claim 1, in which the sheet of soft ferrite has a thickness of less than 0.3 mm.

18. The shield of claim 1, in which the sheet of soft ferrite is made of multiple layers of ferrite.

19. The shield of claim 1, in which the sheet of soft ferrite is made of a combination of different kinds of ferrite material.

20. The shield of claim 1 in which the different kinds of ferrite material are configured to provide a gradual variation of the magnetic permeability across the shield.

21. The shield of claim 1 in which the sheet of soft ferrite includes ferromagnetic powders, and in which the ferromagnetic property of the ferrite depends on grain powder size and/or density.

22. The shield of claim 1 in which the sheet of soft ferrite includes a binder such as resin, melted plastic, flexible polymer, rubber, silicone or any other materials used to fabricate portable electronic device cover or case.

23. The shield of claim 1, in which multi-shot injection moulding is used to obtain different ferromagnetic properties or shielding capabilities in different portions or areas of the shield.

24. The shield of claim 1, in which the shield a cavity has a varying diameter.

25. The shield of claim 1, in which the diameter of the cavity is varied based on the outer diameter of the receiver coil or the distance between transmitter and receiver coils.

26. (canceled)

27. The shield of claim 1, in which the cavity diameter is varied using an adjustment mechanism.

28. The shield of claim 27, in which the adjustment mechanism is located outside or near the shield.

29. The shield of claim 27, in which the adjustment mechanism includes a manual slider or is electronically implemented.

30. (canceled)

31. The shield of claim 1 in which the shield further includes a repeater system including two electrically connected coils, and in which the thin sheet or layer of ferrite is located in between the two electrically connected coils.

32. The shield of claim 31, in which the first coil of the repeater system has dimensions similar to the dimensions of the transmitter coil.

33. The shield of claim 31, in which the second coil of the repeater system has dimensions similar to the dimensions of the receiver coil.

34. The shield of claim 31, in which the electrically connected coils are planar coils fabricated on a PCB or wire wound or a combination of both.

35. The shield of claim 31, in which the shield further includes permanent magnets.

36. The shield of claim 1, in which the two coils of the repeater system are located on the same layer of a flexible substrate and in which the flexible layer is then folded around the sheet of soft ferrite.

37. The shield of claim 1, in which the windings of the coils of the repeater system either have a concentric arrangement or a spiral pattern.

38. A wireless charging system comprising: a) a transmitter coil configured to generate a magnetic flux; b) a receiver coil configured to receive the generated magnetic flux; c) a magnetic shield partly located between the transmitter coil and the receiver coil;
in which the shield is shaped such as to focus or orient a magnetic flux generated by the transmitter coil onto the receiver coil, characterized in that the sheet of soft ferrite includes a cavity or hole.

39-54. (canceled)
